(19) United States
(12) Patent Application Publication
(10) Pub. No.: US 2007/0019549 A1
(43) Pub. Date: Jan. 25, 2007

(54) Communication quality monitoring system, communication quality monitoring device, communication quality degradation point specifying device, and method an program thereof

(75) Inventor: Toshiya Okabe, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC CORPORATION, Tokyo (JP)

(21) Appl. No.: 11/482,843

(22) Filed: Jul. 10, 2006

(30) Foreign Application Priority Data
Jul. 19, 2005 (JP) 208802/2005

(51) Int. Cl. H04L 12/26

(52) U.S. Cl. 370/232

(57) ABSTRACT

A probe device registers a passage history of the probe device itself with a packet, transfers the packet with which the passage history is registered and sends the same to a loss point judging device through a plurality of probe devices. The loss point judging device monitors at least one of a passing path of the packet, an occurrence point at which a packet loss occurs, and a change in a transfer path of the packet, based on the passage history of the packet included in the packet received through the plurality of probe devices.

### BACKGROUND OF THE INVENTION

1. Field of the Invention

The present invention relates to a communication quality monitoring system, a communication quality monitoring device, a communication quality degradation point specifying device, a communication quality monitoring method, a communication quality degradation point specifying method, a communication quality monitoring program, and a communication quality degradation point specifying program, and especially to those to monitor a passing path of packet such as an RTP (Realtime Transport Protocol) to transfer audio and video, a loss point of packet, and a change in a transfer path of packet to monitor a communication quality of packet.

2. Description of Related Art

Conventionally, in order to specify the occurrence of the communication quality degradation, such as the packet loss, and the degradation occurrence point thereof, there is a related art document filed before the present invention, for example, which discloses a quality status monitoring method. The method monitors the network quality by comparing the sending status and the receiving status of the monitoring target packet, and upon finding the quality degradation, judges the quality degradation occurrence section, disposes a plurality of measuring devices on the network, being the quality measurement monitoring target, and performs the quality evaluation by calculating mutual correlation function based on the switch located on the downstream side of the path through which the packet belonging to the above-described detected monitoring target communication flow passes, and instructs the above-described adjacent packet switch to collect the statistics information of the above-described detected monitoring target communication flow collected by the above-described adjacent packet switch, to collect the statistics monitoring information for each communication flow at a low cost (Patent Document 3: Japanese Patent Application Laid-Open No. 2001-257722).

### SUMMARY OF THE INVENTION

Meanwhile, although Patent Document 1 may specify the occurrence of the quality degradation and the occurrence point thereof in the packet network, specifying the passing path of the packet through which the packet loss occurs, the occurrence point at which the packet loss occurs, and the change in the transfer path of the packet based on the passage history of the packet are not considered at all.

Further, although Patent Document 2 is to specify the communication (packet pass) route, based on the packet 42 in which the tracking information collection requirement is set, specifying the passing path of the packet through which the packet loss occurs, the occurrence point at which the packet loss occurs, and the change in the transfer path of the packet based on the passage history of the packet are not considered at all.

Further, Patent Document 3 is the network monitoring method to collect the statistics monitoring information for each communication flow at a low cost, and specifying the passing path of the packet through which the packet loss occurs, the occurrence point at which the packet loss occurs, and the change in the transfer path of the packet based on the passage history of the packet are not considered at all.

The present invention has been made to solve the above circumstances, and an object of the present invention is to provide the communication quality monitoring system, the communication quality monitoring device, the communication quality degradation point specifying device, the communication quality monitoring method, the communication quality degradation point specifying method, the communication quality monitoring program and the communication quality degradation point specifying program to specify at least one of the passing path of the packet through which the packet loss occurs, the occurrence point at which the packet loss occurs, and the change in the transfer path of the packet based on the passage history of the packet to monitor the communication quality of the packet.

In order to achieve the above object, the invention has the following characteristics.

According to the present invention, there is provided a communication quality monitoring device for monitoring a communication quality of a packet, comprising a registering unit, which registers a passage history of the communication quality monitoring device to the packet, and a transferring unit, which transfers the packet with which the passage history is registered by the registering unit.

Further, according to the present invention, there is provided the communication quality monitoring device, wherein the registering unit has a receiving unit, which receives the packet, and a providing unit, which provides the packet received by the receiving unit with an identifier of the communication quality monitoring device, being the passage history, and the registering unit registers the passage history to the packet.

Further, according to the present invention, there is provided the communication quality monitoring device, comprising a holding unit, which obtains a sequence number of a first packet from the first packet received by the receiving unit and holds the sequence number of the obtained first packet, wherein when receiving a second packet by the receiving unit, the registering unit compares the sequence number of the received second packet and the sequence number of the first packet held by the holding unit, and in a case in which the sequence number of the second packet and the sequence number of the first packet are consecutive sequence numbers, registers the passage history with the received second packet.

Further, according to the present invention, there is provided the communication quality monitoring device, wherein the registering unit registers the passage history with a footer of the packet.

Further, according to the present invention, there is provided a communication quality degradation point specifying device for specifying a degradation point of a communication quality of a packet, comprising a monitoring unit, which monitors at least one of a passing path of the packet, an occurrence point at which a loss of the packet occurs, and a change in a transfer path of the packet, based on a passage history of the packet included in the packet.

Further, according to the present invention, there is provided the communication quality degradation point specifying device, wherein the monitoring unit has a receiving unit, which receives the packet, and a duplicating unit, which duplicates the packet received by the receiving unit; and the monitoring unit monitors at least one of the passing path of the packet, the occurrence point at which the loss of the packet occurs, and the change in the transfer path of the packet, based on the passage history of the packet included in the packet duplicated by the duplicating unit.

Further, according to the present invention, there is provided the communication quality degradation point specifying device, wherein the passage history is an identifier to identify a device through which the packet passes, and the monitoring unit monitors at least one of the passing path of the packet, the occurrence point at which the loss of the packet occurs, and the change in the transfer path of the packet, based on the identifier of the packet.

Further, according to the present invention, there is provided the communication quality degradation point specifying device, comprising a deleting unit, which deletes the passage history of the packet included in the packet.

Further, according to the present invention, there is provided a communication quality monitoring system comprising a communication quality monitoring device, which monitors a communication quality of a packet, and a communication quality degradation point specifying unit, which specifies a degradation point of the communication quality of the packet, wherein the communication quality monitoring device has a registering unit, which registers a passage history of the communication quality monitoring device with the packet, and a transferring unit, which transfers the packet with which the passage history is registered by the registering unit, and the communication quality degradation point specifying device has a monitoring unit, which monitors at least one of a passing path of the packet, an occurrence point at which a loss of the packet occurs, and a change in a transfer path of the packet, based on a passage history of the packet included in the packet.

Further, according to the present invention, there is provided the communication quality monitoring system, wherein the communication quality monitoring device has a receiving unit, which receives the packet, and a providing unit, which provides the packet received by the receiving unit with an identifier of the communication quality monitoring device, being the passage history, and the communication quality monitoring device registers the passage history with the packet, and the communication quality degradation point specifying device monitors at least one of the passing path of the packet, the occurrence point at which the loss of the packet occurs, and the change in the transfer path of the packet, based on the identifier of the communication quality monitoring device, being the passage history.

Further, according to the present invention, there is provided the communication quality monitoring system, wherein the communication quality monitoring device has a holding unit, which obtains a sequence number of a first packet from the first packet received by the receiving unit and holds the sequence number of the obtained first packet, and when receiving a second packet by the receiving unit, the communication quality monitoring device compares the sequence number of the received second packet and the sequence number of the first packet held by the holding unit, and in a case in which the sequence number of the second packet and the sequence number of the first packet are consecutive sequence numbers, registers the passage history with the received second packet.

Further, according to the present invention, there is provided the communication quality monitoring system, wherein the communication quality monitoring device registers the passage history to a footer of the packet.

Further, according to the present invention, there is provided the communication quality monitoring system, wherein the communication quality degradation point specifying device has a receiving unit, which receives the packet, and a duplicating unit, which duplicates the packet received by the receiving unit, and the communication quality degradation point specifying device monitors at least one of the passing path of the packet, the occurrence point at which the loss of the packet occurs, and the change in the transfer path of the packet, based on the passage history of the packet included in the packet duplicated by the duplicating unit.

Further, according to the present invention, there is provided the communication quality monitoring system, wherein the communication quality degradation point specifying device has a deleting unit, which deletes the passage history of the packet included in the packet.

Further, according to the present invention, there is provided a communication quality monitoring method, performed at a communication quality monitoring device for monitoring a communication quality of a packet, wherein the communication quality monitoring device performs a registration process to register a passage history of the communication quality monitoring device with the packet, and a transfer process to transfer the packet with which the passage history is registered by the registration process.

Further, according to the present invention, there is provided the communication quality monitoring method, wherein the registration process has a receive process to receive the packet, and a provide process to provide the packet received by the receive process with an identifier of the communication quality monitoring device, being the passage history, and the registration process registers the passage history to the packet.

Further, according to the present invention, there is provided the communication quality monitoring method, wherein the communication quality monitoring device performs a hold process to obtain a sequence number of a first packet from the first packet received by the receive process and hold the sequence number of the received first packet, and when receiving a second packet by the receive process, the register process compares a sequence number of the received second packet and the sequence number of the first packet held by the communication quality monitoring device by the hold process, and in a case in which the sequence number of the second packet and the sequence number of the first packet are consecutive sequence numbers, registers the passage history with the received second packet.

Further, according to the present invention, there is provided the communication quality monitoring method, wherein the register process registers the passage history with a footer of the packet.

Further, according to the present invention, there is provided a communication quality degradation point specifying method performed at a communication quality degradation point specifying device for specifying a degradation point of a communication quality of a packet, wherein the communication quality degradation point specifying device performs a monitor process to monitor at least one of a passing path of the packet, an occurrence point at which a loss of the packet occurs, and a change in a transfer path of the packet, based on a passage history of the packet included in the packet.

Further, according to the present invention, there is provided the communication quality degradation point specifying method, wherein the monitor process has a receive process to receive the packet, and a duplicate process to duplicate the packet received by the receive process, and the monitor process monitors at least one of the passing path of the packet, the occurrence point at which the loss of the packet occurs, and the change in the transfer path of the packet, based on the passage history of the packet included in the packet duplicated by the duplicate process.

Further, according to the present invention, there is provided the communication quality degradation point specifying method, wherein the passage history is an identifier to identify a device through which the packet passes, and the monitor process monitors at least one of the passing path of the packet, the occurrence point at which the loss of the packet occurs, and the change in the transfer path of the packet, based on the identifier.

Further, according to the present invention, there is provided the communication quality degradation point specifying method, wherein the communication quality degradation point specifying device performs a delete process to delete the passage history of the packet included in the packet.

Further, according to the present invention, there is provided a communication quality monitoring program executed at a communication quality monitoring device for monitoring a communication quality of a packet, allowing a registration process to register a passage history of the communication quality monitoring device with the packet, and a transfer process to transfer the packet with which the passage history is registered by the register process to be executed at the communication quality monitoring device.

Further, according to the present invention, there is provided the communication quality monitoring program, wherein the register process has a receive process to receive the packet, and a provide process to provide the packet received by the receive process with an identifier of the communication quality monitoring device, being the passage history, and the registration process registers the passage history to the packet.

Further, according to the present invention, there is provided the communication quality monitoring program, allowing a hold process to obtain a sequence number of a first packet from the first packet received by the receive process and hold the sequence number of the obtained first packet to be executed at the communication quality monitoring device, wherein, when receiving a second packet by the receive process, the register process compares the sequence number of the received second packet and the sequence number of the first packet held by the communication quality monitoring device by the hold process, and in a case in which the sequence number of the second packet and the sequence number of the first packet are consecutive sequence numbers, registers the passage history with the received second packet.

Further, according to the present invention, there is provided the communication quality monitoring program, wherein the register process registers the passage history to a footer of the packet.

Further, according to the present invention, there is provided a communication quality degradation point specifying program executed at a communication quality degradation point specifying device for specifying a degradation point of a communication quality of a packet, allowing the communication quality degradation point specifying device to execute a monitor process to monitor at least one of a passing path of the packet, the occurrence point at which a loss of the packet occurs, and a change in a transfer path of the packet, based on the passage history of the packet included in the packet.

Further, according to the present invention, there is provided the communication quality degradation point specifying program, wherein the monitor process has a receive process to receive the packet, and a duplicate process to duplicate the packet received by the receive process, and the monitor process monitors at least one of the passing path of the packet, the occurrence point at which the loss of the packet occurs, and the change in the transfer path of the packet, based on the passage history of the packet included in the packet duplicated by the duplicate process.

Further, according to the present invention, there is provided the communication quality degradation point specifying program, wherein the passage history is an identifier to identify a device through which the packet is passed, and the monitor process monitors at least one of the passing path of the packet, the occurrence point at which the loss of the packet occurs, and the change in the transfer path of the packet, based on the identifier.

Further, according to the present invention, there is provided the communication quality degradation point specifying program, allowing the communication quality degradation point specifying device to execute a delete process to delete the passage history of the packet included in the packet.

Further, according to the present invention, it is possible to specify at least one of the passing path of the packet through which the packet loss occurs, the occurrence point at which the packet loss occurs, and the change in the transfer path of the packet, based on the passage history of the packet.

### BRIEF DESCRIPTION OF THE DRAWINGS

The foregoing and other objects, aspects and advantages will be better understood from the following detailed description of preferred embodiments of the invention with reference to the following drawings:

FIG. 1 is a view showing a system configuration of a communication quality monitoring system of this embodiment;

FIG. 2 is a view showing a configuration of a probe device composing the communication quality monitoring system of this embodiment;

FIG. 3 is a view showing a configuration of a loss point judging device composing the communication quality monitoring system of this embodiment; and

FIG. 4 is a view illustrating a processing operation in the communication quality monitoring device of this embodiment.

### DETAILED DESCRIPTION OF EXEMPLARY EMBODIMENTS

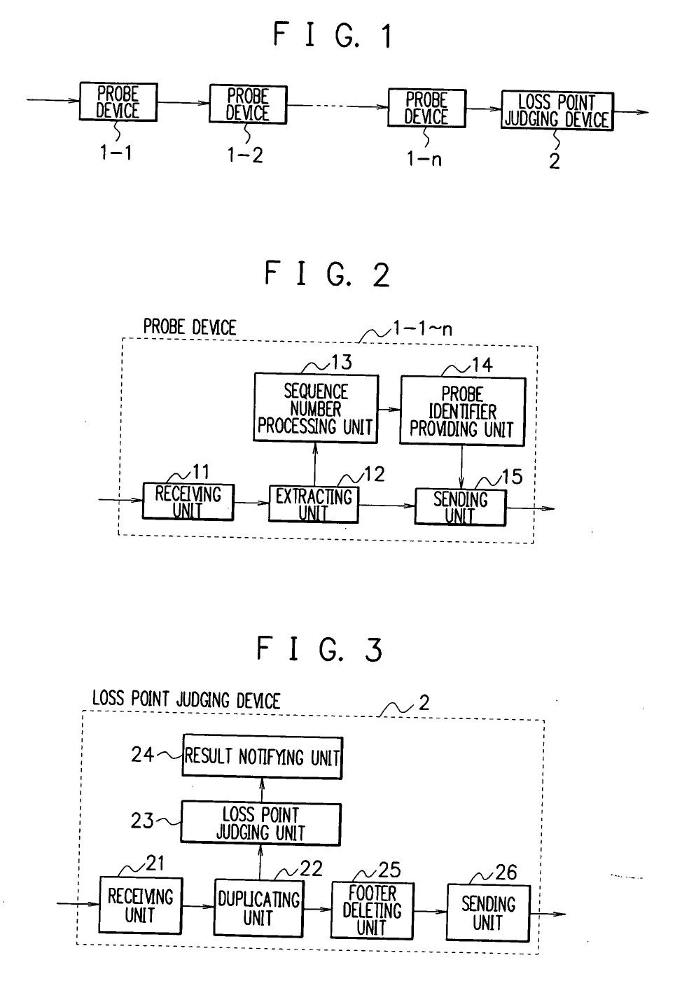

First, the characteristics of a communication quality monitoring system of this embodiment will be described with reference to FIG. 1.

The communication quality monitoring system of this embodiment includes communication quality monitoring devices (1-1˜n: n is an arbitrary integer), which monitors a communication quality of a packet, and a communication quality degradation point specifying device (2), which specifies a degradation point of the communication quality of packets. And, each device (1-1˜n) registers packet's passage history in a packet, transfers the packet to the device (2) through communication quality monitoring devices (1-1˜n). The device (2) monitors at least one of the followings: a passing path of packets; a point where loss of packets occurs; and a change in a transfer path of packets, based on the passage history in the packets received through the devices (1-1˜n).

In this manner, the communication quality monitoring system of this embodiment is capable of specifying the passing path of packets with a small amount of calculation and message, without requiring a large amount of calculation and message, by monitoring the passing path of packets based on passage histories of packets.

Further, by monitoring points at which the loss of packets occurs based on passage histories of packets, it is possible to specify a point where the loss of packets occurs even when only one packet is lost.

Further, by monitoring a change in a transfer path of packets based on passage histories, it is possible to detect the change when a passing path changes.

Hereinafter, the communication quality monitoring system of this embodiment will be described with reference to the attached drawings.

First, a system configuration of the communication quality monitoring system of this embodiment will be described with reference to FIG. 1.

The communication quality monitoring system of this embodiment includes probe devices (1-1˜in: n is an arbitrary integer) and a loss point specifying device (2). The probe devices (1-1˜in) and the loss point specifying device are disposed within a communication network.

<Probe Device 1-1˜n>

Next, the probe devices (1-1˜n) will be described with reference to FIG. 2.

Each of probe devices (1-1˜n) of this embodiment is configured to monitor traffic of RTP packets, which pass through the probe devices (1-1˜n), and includes a receiving unit (11), an extracting unit (12), a sequence number processing unit (13), a probe identifier providing unit (14) and a sending unit (15), as shown in FIG. 2.

The receiving unit (11) is configured to receive RTP packets. The extracting unit (12) is configured to extract RTP packets. The sequence number processing unit (13) is configured to hold a sequence number included in a header of an RTP packet. The probe identifier providing unit (14) is configured to provide an RTP packet with a probe identifier, based on an instruction from the sequence number processing unit (13). The sending unit (15) is configured to send RTP packets.

The probe device (1-1) of this embodiment receives an RTP packet at the receiving unit (11) and sends the RTP packet to the extracting unit (12). The extracting unit (12) extracts the sequence number of the RTP packet included in the header of the RTP packet, and sends the sequence number to the sequence number processing unit (13). This allows the sequence number processing unit (13) to hold the sequence number of the RTP packet extracted at the extracting unit (12). The extracting unit (12) sends the RTP packet sent from the receiving unit (11) to the sending unit (15), and the sending unit (15) sends the RTP packet to the next probe device (1-2).

Next, upon receipt of the sequence number of the next RTP packet from the extracting unit (12), the sequence number processing unit (13) compares the sequence number previously held and the sequence number of the next RTP packet, and judges whether the two sequence numbers are consecutive sequence numbers. Then the unit (13) determines whether the RTP packet with the sequence number previously held was transferred from the sending unit (15) to the next probe device (1-2).

When the sequence number processing unit (13) judges that the sequence number previously held and the sequence number of the next RTP packet are consecutive sequence numbers, the unit (13) determines that the RTP packet with the adjacent sequence number passed through the own probe device (1-1) and notifies the probe identifier providing unit (14) that the RTP packet with the adjacent sequence number passed through the own probe device (1-1). This allows the probe identifier providing unit (14) to judge that the RTP packet with the adjacent sequence number has passed through the own probe device (1-1).

When the probe identifier providing unit (14) judges that the RTP packet with the adjacent sequence number has passed the probe device (1-1) based on information notified by the sequence number processing unit (13), the unit (14) sends a probe identifier, an identifier of the probe device (1-1), to the sending unit (15).

When the sending unit (15) is provided with the probe identifier by the unit (14), the unit (15) adds the probe identifier to a footer at the end of the next RTP packet sent from the extracting unit (12), and transfers the RTP packet to which the probe identifier of the probe device (1-1) is added to the next probe device (1-2).

<Loss Point Judging Device 2>

Next, the loss point judging device (2) will be described with reference to FIG. 3.

The loss point judging device (2) of this embodiment is configured to monitor at least one of the followings: a passing path of RTP packet; a loss point of RTP packet; and a change in a transfer path of packet. The device (2) includes a receiving unit (21), a duplicating unit (22), a loss point judging unit (23), a result notifying unit (24), a footer deleting unit (25), and a sending unit (26), as shown in FIG. 3.

The receiving unit (21) is configured to receive RTP packets. The duplicating unit (22) is configured to duplicate RTP packets. The loss point judging unit (23) is configured to judge the passing path of RTP packet, the loss point of RTP packet, and the change in the transfer path of packet. The result notifying unit (24) is configured to notify a judgment result judged at the loss point judging unit (23) to the outside. The footer deleting unit (25) is configured to delete the probe identifier added to an RTP packet. The sending unit (26) is configured to send RTP packets.

The loss point judging device (2) of this embodiment duplicates the RTP packet received by the receiving unit (21) at the duplicating unit (22), and sends the duplicated RTP packet to the loss point judging unit (23) and the footer deleting unit (25).

The loss point judging unit (23) monitors the passing path of RTP packet, the loss point of RTP packet, and the change in the transfer path of packet, based on an probe identifier string stored in a footer part of the RTP packet duplicated at the duplicating unit (22), and sends a monitored result to the result notifying unit (24). The result notifying unit (24) notifies the result sent from the loss point judging unit (23) to the outside.

Further, the footer deleting unit (25) deletes the probe identifier added to the footer of the RTP packet sent from the duplicating unit (22), and sends the RTP packet from which the probe identifier is deleted to the sending unit (26) and the sending unit (26) sends the same to the outside.

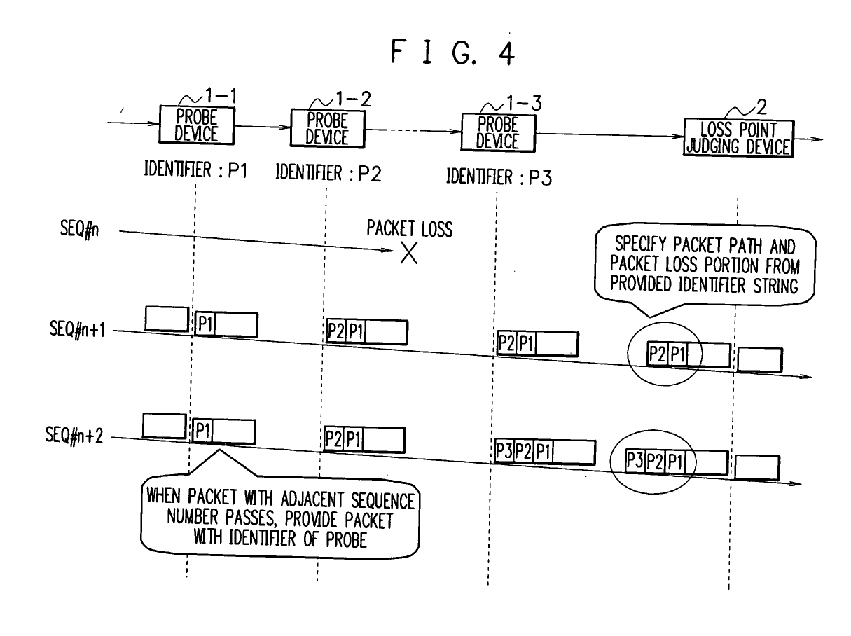

Next, a processing operation in the communication monitoring system of this embodiment will be described with reference to FIG. 4.

First, as shown in FIG. 4, the behavior of the RTP packet with a sequence number seq#n+1, which follows the RTP packet with a sequence number seq#n, under the situation where the RTP packet with the sequence number seq#n passes through the probe devices (1-1) and (1-2), and a loss (packet loss) occurs between the probe device (1-2) and the probe device (1-3), will be described.

In this case, the RTP packet with the sequence number seq#n passes through the probe devices (1-1) and (1-2). Therefore, the sequence number seq#n is stored in the sequence number processing unit (13) of each of the probe devices (1-1) and (1-2).

Next, when the RTP packet with the sequence number seq#n+1, which is the following RTP packet of the RTP packet with the sequence number seq#n, passes through the probe device (1-1), the sequence number processing unit (13) compares the sequence number seq#n held by the unit (13) and the sequence number seq#n+1of the following RTP packet received by the receiving unit (11). By doing so, the unit (13) judges that the sequence number seq#n of the RTP packet held by the unit (13) in advance and the sequence number seq#n+1 of the following RTP packet received by the receiving unit (11) are the consecutive sequence numbers, and judges that the adjacent RTP packet, that is, the RTP packet with the sequence number seq#n passes through the probe device (1-1), and notifies this to the probe identifier providing unit (14).

When the probe identifier providing unit (14) judges that the RTP packet with the sequence number seq#n passes through the probe device (1-1) based on the information notified by the sequence number processing unit (13), this sends a probe identifier P1, an identifier of the probe device (1-1), to the sending unit (15).

The sending unit (15) adds the probe identifier P1 sent from the probe identifier providing unit (14) to the footer of the RTP packet with the sequence number seq#n+1 sent from the extracting unit (12) and sends the same to the next probe device (1-2).

Next, when the RTP packet with the sequence number seq#n+1 passes through the probe device (1-2), since the sequence number processing unit (13) of the probe device (1-2) holds the adjacent sequence number seq#n, the sending unit (15) adds a probe identifier (P2) of the probe device (1-2) to the footer of the RTP packet with the sequence number seq#n+1 and sends the same to a next probe device (1-3), as in the above-described processing operation in the probe device (1-1).

When the RTP packet with the sequence number seq#n+1 passes through the probe device (1-3), since the sequence number processing unit (13) of the probe device (1-3) does not hold the adjacent sequence number seq#n, the unit (13) judges that the RTP packet with the adjacent sequence number seq#n has not passed. In this case, the sequence number processing unit (13) does not notify the probe identifier providing unit (14) that the RTP packet with the adjacent sequence number seq#n has passed, and the probe identifier providing unit (14) does not send a probe identifier (P3) of the probe device (1-3) to the sending unit (15).

Therefore, when the RTP packet with the sequence number seq#n+1 passes through the probe device (1-3), the probe device (1-3) does not add the probe identifier (P3) of the probe device (1-3) to the footer of the RTP packet with the sequence number seq#n+1, and transfers the RTP packet with the sequence number seq#n+1 without change.

Next, the loss point judging device (2), which receives the RTP packet with the sequence number seq#n+1, specifies the passing path of the RTP packet, the loss point of the RTP packet, and the change in the transfer path of the packet based on the probe identifier string recorded in the footer of the RTP packet with the sequence number seq#n+1, at the loss point judging unit (23).

The loss point judging unit (23) specifies that the RTP packet with the sequence number seq#n, which is the adjacent RTP packet of the RTP packet with the sequence number seq#n+1, passes through the probe devices (1-1) and (1-2), and then is lost between the probe device (1-2) and the probe device (1-3), based on a probe identifier string “P1, P2”.

Next, the case where the RTP packet with the sequence number seq#n+2 passes through the probe devices (1-1), (1-2) and (1-3) and arrives at the loss point judging device (2), will be described.

In this case, the RTP packet with the adjacent sequence number seq#n+1 passes through the probe devices (1-1), (1-2) and (1-3). Therefore, the sequence number seq#n+1 is stored in the sequence number processing unit (13) of each of the probe devices (1-1˜3).

Therefore, when the RTP packet with the sequence number seq#n+2 passes through the probe devices (1-1), (1-2) and (1-3), the probe identifiers (P1, P2 and P3) of the probe devices (1-1˜3), respectively, are added to the footer of the RTP packet with the sequence number seq#n+2. When the RTP packet with the sequence number seq#n+2 arrives at the loss point judging device (2), the loss point judging unit (23) can specify that the RTP packet with the sequence number seq#n+1, which is the adjacent RTP packet of the RTP packet with the sequence number seq#n+2, passes through the probe devices (1-1˜3) and that the packet loss does not occur, based on a probe identifier string “P1, P2, P3”.

In this manner, in the communication quality monitoring system of this embodiment, when a probe device (1-1˜n) receives the RTP packet, the probe device (1-1˜n) judges whether the adjacent RTP packet of the received RTP packet passes through the probe device (1-1˜n) or not, and when this judges that the adjacent RTP packet passes through the probe device (1-1˜n), the probe device (1-1˜n) provides the footer at the end of the received RTP packet with the identifier of the probe device and sends the same to the outside. And, when the loss point judging device (2) receives the RTP packet, the loss point judging device (2) analyzes the probe identifier string recorded in the footer at the end of the received RTP packet to specify the passing path of the adjacent RTP packet of the RTP packet in which the probe identifier string is recorded. Therefore, the loss point judging device (2) can specify the passing path of an RTP packet with a small calculation load, without adding up each sending history of an individual RTP packet, which is monitored by each probe device (1-1˜n).

Further, in the communication monitoring system of this embodiment, when the probe device (1-1˜n) receives an RTP packet, the probe device (1-1˜n) judges whether the adjacent RTP packet of the received RTP packet passes through the probe device (1-1˜n), and when this judges that the adjacent RTP packet does not pass through the probe device (1-1˜n) and that the adjacent RTP packet is lost, this does not provide the footer at the end of the received RTP packet with the identifier of the probe device, and transfers the same to the outside without change. And, also in the following probe device (1-1˜n), these devices do not provide the footer at the end of the RTP packet with the identifier of a probe device itself, and transfers the same to the outside without change. Therefore, the footer of the RTP packet is not provided with the probe identifier of a probe device after the point at which the adjacent RTP packet is lost. And, the loss point judging device (2) judges that the footer of the RTP packet is not provided with the probe identifiers of the probe devices after the point at which the adjacent RTP packet is lost, by analyzing the probe identifier string recorded in the footer of the RTP packet, so that it is possible to specify the loss point at which the RTP packet is lost, when even one adjacent RTP packet of the RTP packet in which the probe identifier string is recorded is lost.

Further, the loss point judging device (2) can specify the change in a passing path of RTP packet when the change in the passing path occurs, by analyzing the probe identifier string recorded in the footer at the end of an RTP packet and examining the change in the probe identifier string.

Further, when irregular events occur such as the loss of RTP packet, the reverse of an arriving order of RTP packet, and fluctuation of the transfer path of RTP packet, it is possible to specify the reason thereof from the probe identifier string, which is provided to the RTP packet when the packet transfer gets back to normal.

Incidentally, detection of the loss of the RTP packet and the reverse of an arriving order of RTP packet may be performed with existing methods used in an RTP that monitors the sequence number.

Furthermore, the above-described embodiments are exemplary embodiments of the present invention, and are not intended to limit the scope of the present invention thereto. The present invention may be embodied with various modifications without departing from the scope of the invention.

For example, in the above-described communication quality monitoring system, although the probe identifier is provided to the footer at the end of the RTP packet in the probe devices (1-1˜n), it is not limited to providing a probe identifier, and it is possible to provide a time stamp in addition to the probe identifier. Thereby, it becomes possible to know a passing time of an RTP packet and an occurrence time of the packet loss at the loss point judging device (2).

Further, in the above-described communication quality monitoring system, although the probe identifier is provided to the footer at the end of an RTP packet in the probe devices (1-1˜n), a portion to which the probe identifier is provided is not limited to the footer at the end of the RTP packet, and any method to provide the probe identifier to the RTP packet may be applied.

Further, the probe devices (1-1˜n) and the loss point judging device (2) composing the above-described communication quality monitoring system may be executed not only by hardware but also by software such as a computer program, and it is possible to execute the above-described processing operation in a communication device and an information processing device, by recording the program in a recording media, such as an optical recording media, a magnetic recording media, an optical magnetic recording media, or a semiconductor, and allowing the communication device such as a rooter and an information processing device such as a personal computer to load the program from the recording media. And, it is also possible to execute the above-described processing operation in a communication device and an information processing device by allowing the communication device and the information processing device to load the program from an external device connected to the same through a predetermined network.

The present invention may be applied to a system, which monitors a communication quality of packets.

1. A communication quality monitoring device for monitoring a communication quality of packets, comprising:
a registering unit, which registers a passage history of a packet through said communication quality monitoring device; and
a transferring unit, which transfers the packet to which said passage history is registered by said registering unit.

2. The communication quality monitoring device according to claim 1,
wherein said registering unit comprises
a receiving unit, which receives the packet, and
a providing unit, which provides the packet received by said receiving unit with an identifier of said communication quality monitoring device, the identifier being said passage history; and
said registering unit registers said passage history to the packet.

3. The communication quality monitoring device according to claim 2, comprising:
a holding unit, which obtains a sequence number of a first packet from the first packet received by said receiving unit and holds the sequence number of the first packet;
wherein when said receiving unit receives a second packet, the registering unit compares the sequence number of the second packet and the sequence number of the first packet, and when the sequence number of the second packet and the sequence number of the first packet are consecutive sequence numbers, the registering unit registers the passage history of the second packet.

4. The communication quality monitoring device according to claim 1, wherein said registering unit registers the passage history to a footer of the packet.

5. A communication quality degradation point specifying device for specifying a degradation point of a communication quality of a packet, comprising
a monitoring unit, which monitors at least one of the followings: a passing path of packet; an occurrence point at which a loss of packet occurs; and a change in a transfer path of packet, based on a passage history of packet included in the packet.

6. The communication quality degradation point specifying device according to claim 5,
wherein said monitoring unit comprises a receiving unit, which receives said packet, and
a duplicating unit, which duplicates a packet received by said receiving unit; and
said monitoring unit monitors at least one of the followings: a passing path of packet; occurrence point at which loss of packet occurs; and a change in a transfer path of packet, based on the passage history of packet included in the packet duplicated by said duplicating unit.

7. The communication quality degradation point specifying device according to claim 5,
wherein said passage history is an identifier to identify a device through which a packet passes, and
said monitoring unit monitors at least one of the followings: a passing path of packet; occurrence point at which loss of packet occurs; and a change in the transfer path of said packet, based on the identifier.

8. The communication quality degradation point specifying device according to claim 5, comprising a deleting unit, which deletes the passage history of packet included in a packet.

9. A communication quality monitoring system comprising:
a communication quality monitoring device, which monitors a communication quality of packets; and
a communication quality degradation point specifying unit, which specifies a degradation point of the communication quality of a packet,
wherein said communication quality monitoring device has a registering unit, which registers a passage history of said communication quality monitoring device to a packet, and
a transferring unit, which transfers the packet to which said passage history is registered by the registering unit; and
said communication quality degradation point specifying device comprising a monitoring unit, which monitors at least one of the followings: a passing path of packet, an occurrence point at which a loss of packet occurs, and a change in a transfer path of packet, based on a passage history of packet included in a packet.

10. The communication quality monitoring system according to claim 9,
wherein said communication quality monitoring device includes a receiving unit, which receives a packet, and
a providing unit, which provides the packet received by said receiving unit with an identifier of said communication quality monitoring device, the identifier being said passage history; and
said communication quality monitoring device registers the passage history to the packet, and
said communication quality degradation point specifying device monitors at least one of the followings: the passing path of packet; the occurrence point at which the loss of packet occurs; and the change in the transfer path of packet, based on the identifier of said communication quality monitoring device, the identifier being said passage history.

11. The communication quality monitoring system according to claim 10,
wherein said communication quality monitoring device including a holding unit, which obtains a sequence number of a first packet from the first packet received by said receiving unit and holds the sequence number of the first packet, and
when the receiving unit receives a second packet, the communication quality monitoring device compares the sequence number of the second packet and the sequence number of the first packet held by said holding unit, and when the sequence number of the second packet and the sequence number of the first packet are consecutive sequence numbers, registers said passage history to the second packet.

12. The communication quality monitoring system according to claim 9, wherein said communication quality monitoring device registers said passage history to a footer of a packet.

13. The communication quality monitoring system according to claim 9,
wherein said communication quality degradation point specifying device includes a receiving unit, which receives a packet, and a duplicating unit, which duplicates the packet received by said receiving unit; and
said communication quality degradation point specifying device monitors at least one of the followings: the passing path of packet; the occurrence point at which the loss of packet occurs; and the change in the transfer path of packet, based on the passage history of packet included in the packet duplicated by said duplicating unit.

14. The communication quality monitoring system according to claim 9, wherein said communication quality degradation point specifying device comprises a deleting unit, which deletes the passage history of packet included in a packet.

15. A communication quality monitoring method, performed at a communication quality monitoring device for monitoring a communication quality of packet, wherein said communication quality monitoring device performs a registration process to register a passage history of said communication quality monitoring device to a packet, and a transfer process to transfer the packet to which said passage history is registered by said registration process.

16. The communication quality monitoring method according to claim 15,
wherein said registration process comprises a receive process to receive packets, and
a provide process to provide the packet received by said receive process with an identifier of said communication quality monitoring device, the identifier being said passage history; and
said registration process registers said passage history to the packet.

17. The communication quality monitoring method according to claim 16,
wherein said communication quality monitoring device performs a hold process to obtain a sequence number of a first packet and hold the sequence number of the first packet, and
when said receive process receives a second packet, said register process compares a sequence number of the second packet and the sequence number of the first packet, and when the sequence number of the second packet and the sequence number of the first packet are consecutive sequence numbers, registers said passage history to the second packet.

18. The communication quality monitoring method according to claim 15, wherein said register process registers said passage history to a footer of a packet.

19. A communication quality degradation point specifying method performed at a communication quality degradation point specifying device for specifying a degradation point of a communication quality of a packet,
wherein said communication quality degradation point specifying device performs a monitor process to monitor at least one of the followings: a passing path of packet; an occurrence point at which a loss of packet occurs; and a change in a transfer path of packet, based on a passage history of packet included in a packet.

20. The communication quality degradation point specifying method according to claim 19,
wherein said monitor process comprises a receive process to receive packets, and
a duplicate process to duplicate a packet received by said receive process; and
said monitor process monitors at least one of the followings: the passing path of packet; the occurrence point at which the loss of packet occurs; and the change in the transfer path of packet, based on the passage history of packet included in the packet duplicated by said duplicate process.

21. The communication quality degradation point specifying method according to claim 19,
wherein said passage history is an identifier to identify a device through which a packet passes, and
said monitor process monitors at least one of the followings: the passing path of packet; the occurrence point at which the loss of packet occurs; and the change in the transfer path of packet, based on the identifier.

22. The communication quality degradation point specifying method according to claim 19, wherein said communication quality degradation point specifying device performs a delete process to delete the passage history of packet included in the packet.

23. A communication quality monitoring program for a communication quality monitoring device for monitoring a communication quality of a packet, causing the communication quality monitoring device to execute a registration process to register a passage history of said communication quality monitoring device to the packet, and a transfer process to transfer the packet to which said passage history is registered by said register process.

24. The communication quality monitoring program according to claim 23,
wherein said register process comprises a receive process to receive a packet, and
a provide process to provide the packet received by said receive process with an identifier of said communication quality monitoring device, the identifier being said passage history; and
said registration process registers said passage history to the packet.

25. The communication quality monitoring program according to claim 24, causing the communication quality monitoring device to execute a hold process to obtain a sequence number of a first packet from the first packet received by said receive process and hold the sequence number of the first packet,
wherein, when the receive process receives a second packet, said register process compares the sequence number of the second packet and the sequence number of the first packet held by said communication quality monitoring device by said hold process, and when the sequence number of the second packet and the sequence number of the first packet are consecutive sequence numbers, registers said passage history to the second packet.

26. The communication quality monitoring program according to claim 23, wherein said register process registers said passage history to a footer of a packet.

27. A communication quality degradation point specifying program for a communication quality degradation point specifying device for specifying a degradation point of a communication quality of a packet, causing the communication quality degradation point specifying device to execute a monitor process to monitor at least one of the followings: a passing path of packet; the occurrence point at which a loss of packet occurs; and a change in a transfer path of packet, based on the passage history of packet included in the packet.

28. The communication quality degradation point specifying program according to claim 27,
wherein said monitor process comprises a receive process to receive the packet, and
a duplicate process to duplicate the packet received by said receive process, and
said monitor process monitors at least one of the followings: the passing path of packet; the occurrence point at which the loss of packet occurs; and the change in the transfer path of packet, based on the passage history of packet included in the packet duplicated by said duplicate process.

29. The communication quality degradation point specifying program according to claim 27,
wherein said passage history is an identifier to identify a device through which a packet is passed, and
said monitor process monitors at least one of the followings: the passing path of packet; the occurrence point at which the loss of packet occurs; and the change in the transfer path of packet, based on said identifier.

30. The communication quality degradation point specifying program according to claim 27, causing said communication quality degradation point specifying device to execute a delete process to delete the passage history of packet included in the packet.
